(19) United States
(12) Patent Application Publication
(10) Pub. No.: US 2026/0213922 A1
(43) Pub. Date: Jul. 23, 2026

(54) Secure Storage and Management of Sensitive Information

(71) Applicant: Comcast Cable Communications, LLC, Philadelphia, PA (US)

(72) Inventors: Stuart Bercun, Medford, NJ (US); Fei Wan, Warrington, PA (US); Sudhakar Yadav, Chester Springs, PA (US); Shadik Khan, Exton, PA (US)

(21) Appl. No.: 19/029,656

(22) Filed: Jan. 17, 2025

(51) Int. Cl. H04L 9/08; G06F 21/62

(52) U.S. Cl. CPC H04L 9/0822; G06F 21/6245; H04L 9/0861

(57) ABSTRACT

Systems, apparatuses, and methods are described for securely storing and managing sensitive information. A gateway may manage the encryption and storage of the sensitive information. A mobile device may be authenticated by the gateway using a local connection between the gateway and the mobile device. The mobile device may access, encrypt and/or decrypt the sensitive information based on being authenticated by the gateway. As an added layer of security, the gateway may re-encrypt the sensitive information when the mobile device is disconnected from the gateway and/or based on a period of time associated with the storing of the sensitive information. The mobile device may receive the re-encrypted information after reconnecting and/or being reauthenticated with the gateway.

### BACKGROUND

The secure storage and management of sensitive information using, for example, a centralized cloud infrastructure, may create a concentration of risk, in the event that the cloud storage is comprised by malicious actors. When a breach occurs, all sensitive information that was stored in the cloud may be accessed all at once, which may cause, in some instances, the release of millions of users'sensitive information. This may result in the use of the sensitive information for malign purposes, such as the unwanted access of user applications and/or other sensitive personal information.

### SUMMARY

The following summary presents a simplified summary of certain features. The summary is not an extensive overview and is not intended to identify key or critical elements.

Systems, apparatuses, and methods are described for securely storing and managing sensitive information, for example, username and password pairs for applications. A gateway may manage encryption and storage of the sensitive information. A mobile device may be authenticated by the gateway using a local connection between the gateway and the mobile device. The gateway may store encrypted sensitive information from the mobile device. The mobile device may access the sensitive information based on being authenticated by the gateway. As an added layer of security, the gateway may re-encrypt the sensitive information when the mobile device is disconnected from the gateway or based on a period of time associated with the storing of the sensitive information. The mobile device may receive the re-encrypted information after reconnecting and/or being reauthenticated with the gateway. Advantages of systems, apparatuses, and methods described herein may include additional security related to the storing and management of sensitive information.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 is a block diagram of a system that manages sensitive information.

FIGS. 4A-D are a sequence diagram showing an example method for securely storing and managing sensitive information.

FIG. 5 is a flow chart showing an example method for using a gateway to securely store and manage sensitive information.

FIG. 6 shows an example of a user interface.

FIGS. 7A-B are a flow chart showing an example method using a mobile device to send sensitive information to a gateway and retrieve sensitive information from the gateway.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

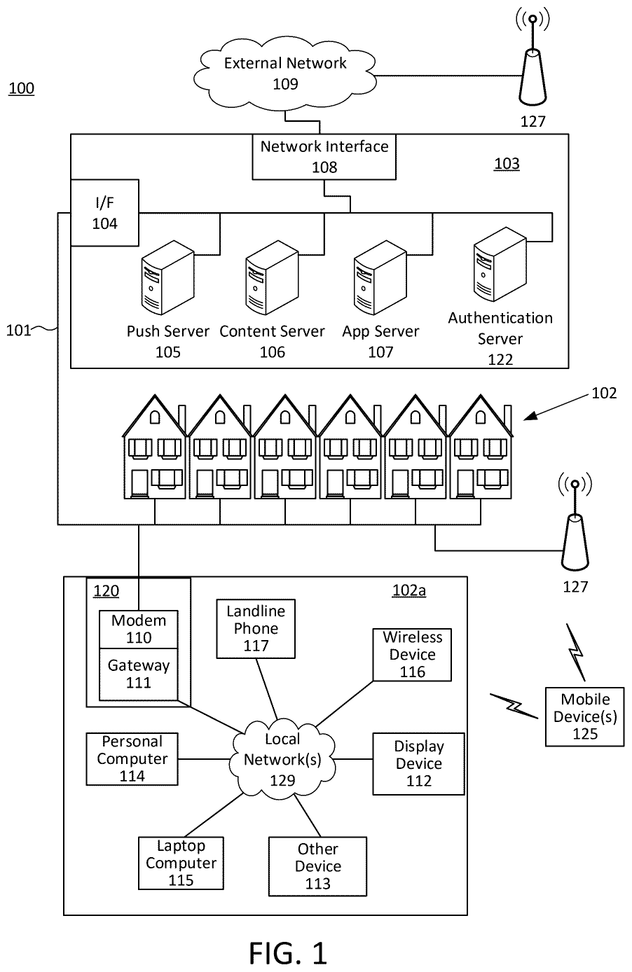

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the authentication server 122 (described below), additional push, content, and/or application servers, and/or other types of servers. The authentication server 122 may be configured to receive information from a mobile device 125 via the gateway 111 (e.g., information that identifies the mobile device 125 as being an approved device, which the application server 122 may use to authenticate the mobile device 125). For example, the authentication server 122 may be responsible for authenticating the mobile device 125 by comparing a serial number corresponding to the mobile device 125 with a database of serial numbers stored at the authentication server 122. In finding a match between the serial number of the mobile device 125 and one of the serial numbers that are stored at the authentication server 122, the authentication server 122 may authenticate the mobile device 125. Although shown separately, the push server 105, the content server 106, the application server 107, the authentication server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein. Also or alternatively, one or more of servers 105, 106, 107, and 122, and/or other servers, may be part of the external network 109 and may be configured to communicate (e.g., via the local office 103) with computing devices located in or otherwise associated with one or more premises 102.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks 129, with devices in the premises 102a. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. As such, the local network 129 may be used by any of the devices in the premises 102a to communicate with each other and the gateway 111. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

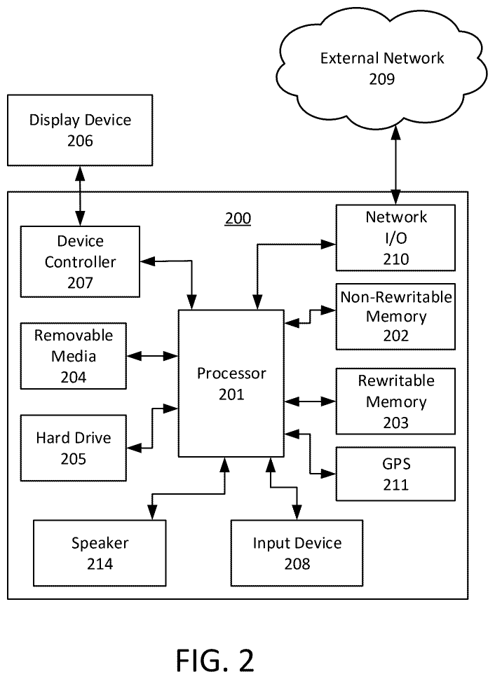

FIG. 2 shows hardware elements of a computing device 200 that may be used to implement any of the computing devices shown in FIG. 1 (e.g., the gateway 111, any of the other devices shown in the premises 102a, the mobile devices 125, any of the devices shown in the local office 103, any of the wireless access points 127, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network (e.g., a local network 129), a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

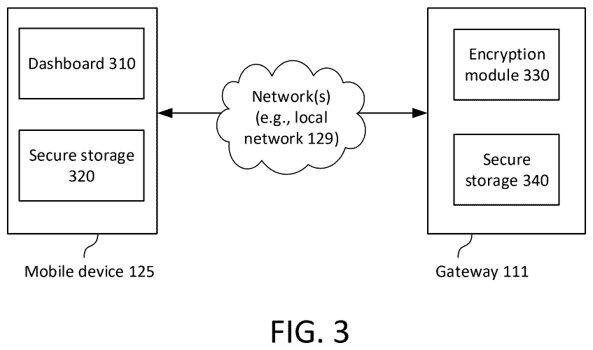

FIG. 3 is a block diagram of a system that manages sensitive information, which may comprise the mobile device 125, the gateway 111, and one or more networks via which the mobile device 125 and the gateway 111 may communicate. The mobile device 125 may comprise a dashboard 310 and a secure storage 320. The gateway 111 may also comprise an encryption module 330 and a secure storage 340. The one or more networks may comprise the local network 129. Also or alternatively, the one or more networks may comprise one or more wide area networks (e.g., the Internet, an LTE, 5G, or other wide area networks) and/or one or more other local networks. For example, the mobile device may be part of a local area network in a premises 102 (that is different from the premises 102a in which the gateway 111 is located) and may communicate, via that local network and the Internet with the gateway 111.

The dashboard 310 may comprise an application that a user of the mobile device 125 may use to authenticate the mobile device 125 with the gateway 111, enter one or more username and password pairs, retrieve and/or access an application corresponding to the one or more username and password pairs, and/or perform other functions, as discussed in more detail below. For example, a user may input information into the dashboard 310, such as login information that may be used by a service provider associated with the gateway 111 to verify the authenticity of the user. Also or alternatively, the gateway 111 may verify the authenticity of the user.

The secure storage 320 may be hardware (e.g., secure memory such as electrically erasable programmable read-only memory (EEPROM), or the like) dedicated to storing data, for example, an encryption key, which the mobile device 125 may use to decrypt sensitive information in order to access an application that a user associated with the mobile device 125 would like to use, as discussed in more detail below. For example, sensitive information that was encrypted and subsequently stored at the gateway 111 may be sent to the mobile device 125 and decrypted using the encryption key stored at secure storage 320. This may allow the user associated with the mobile device 125 to access an application (e.g., access an external service associated with the application, such as a streaming application) associated with the sensitive information (e.g., a username and password pair to login to the application).

Encryption module 330 may any combination of hardware and/or software at the gateway 111 dedicated to generating an encryption key, encrypting and/or decrypting sensitive information received from the mobile device 125. For example, upon authenticating mobile device 125 and receiving sensitive information from the mobile device 125 (e.g., one or more username and password pairs corresponding to one or more applications), the gateway 111 may encrypt the sensitive information using the encryption key that was generated using the encryption module 330. The gateway 111 may send the encryption key to the mobile device 125 so that the mobile device 125 may encrypt and/or decrypt the sensitive information. Secure storage 340 may be hardware dedicated to storing, for example, the encryption key and/or encrypted sensitive information, such as EEPROM or the like. For example, after encrypting sensitive information from the mobile device 125, the gateway 111 may store the encrypted sensitive information at secure storage 340.

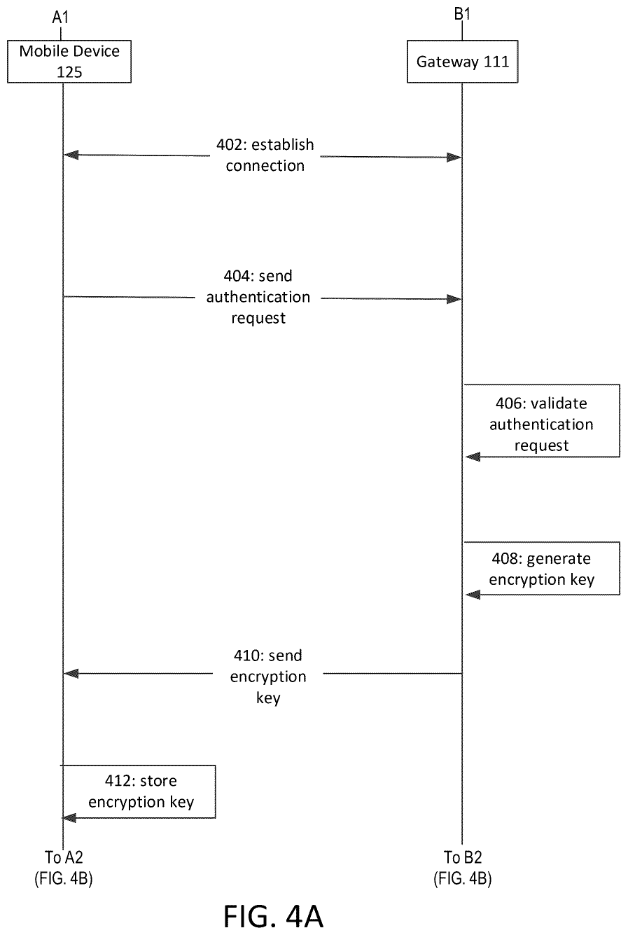

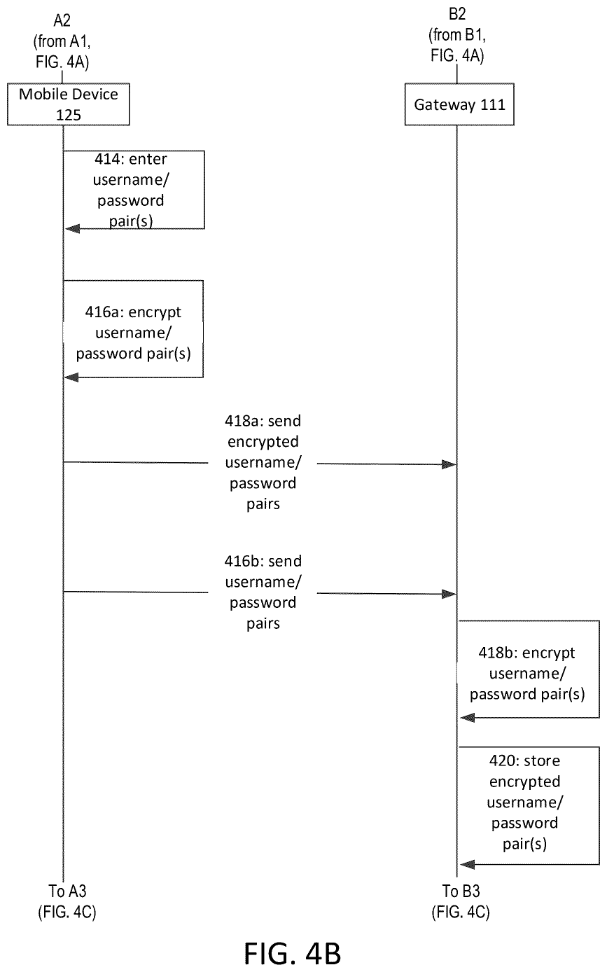

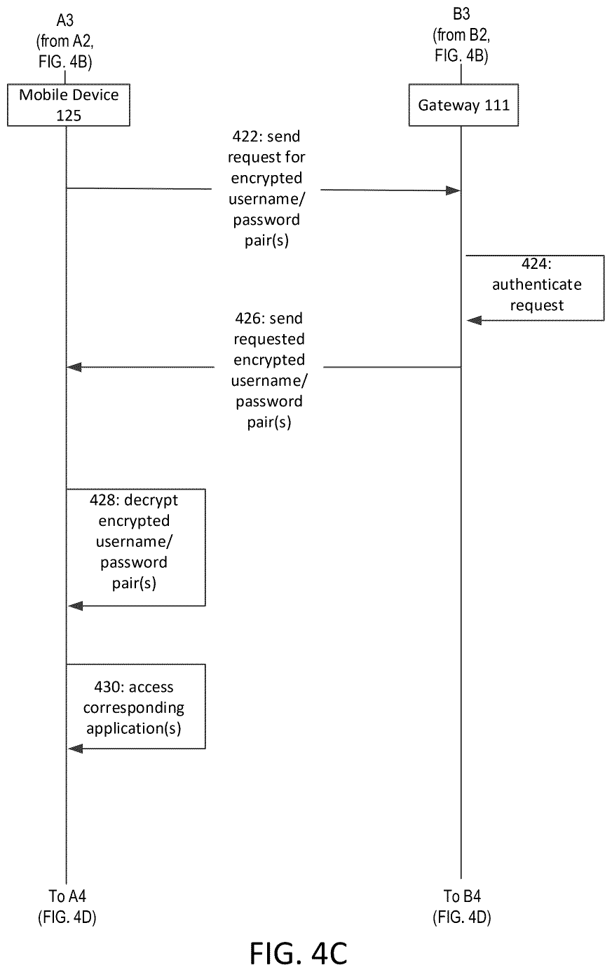

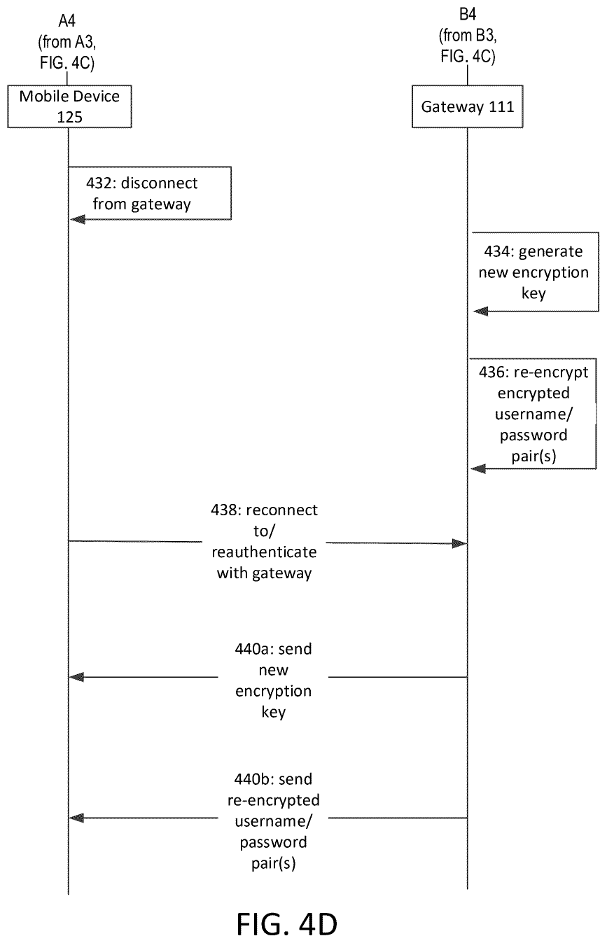

FIGS. 4A-4D are a sequence diagram showing an example method for securely storing and managing sensitive information. Vertical lines A1 (FIG. 4A), A2 (FIG. 4B), A3 (FIG. 4C), and A4 (FIG. 4B) correspond to the mobile device 125. Vertical lines B1 (FIG. 4A), B2 (FIG. 4B), B3 (FIG. 4C), and B4 (FIG. 4B) correspond to the gateway 111. FIG. 4B is a continuation of FIG. 4A, as indicated at the bottom of FIG. 4A and at the top of FIG. 4B. FIG. 4C is a continuation of FIG. 4B, as indicated at the bottom of FIG. 4B and at the top of FIG. 4C. FIG. 4D is a continuation of FIG. 4C, as indicated at the bottom of FIG. 4C and at the top of FIG. 4D. Although FIGS. 4A-4D shows certain computing devices from FIG. 1 as examples of computing devices that may perform one of more of the steps described below, one, some, or all of those steps may be performed by one or more other computing devices. The devices shown in FIGS. 4A-4D (and/or other computing devices) may be configured (e.g., based on stored instructions) to perform steps such as are described herein. One or more of the communications and/or steps shown in FIGS. 4A-4D may be rearranged, omitted, and/or otherwise modified, and/or other steps and/or communications added. A communication shown in, and/or described in connection with, FIGS. 4A-4D need not be a single message nor contained in a single packet, block, or other transmission unit.

Referring to FIG. 4A, at step 402, the gateway 111 may establish a connection with the mobile device 125. Although that connection may be via one or more networks (e.g., as described in connection with FIG. 3), for convenience the examples of FIGS. 4A-D assume that the connection is via the local network 129. For example, the gateway 111 and the mobile device 125 may establish a connection via the local network 129. For example, the mobile device 125 may establish the connection with the gateway 111 using login information such as a service set identifier (SSID) and password combination. Also or alternatively, the connection may comprise a secure connection between the mobile device 125 and the gateway 111 (using a secure connection protocol, e.g., wired equivalent privacy (WEP), WiFi Protected Access (WPA), WiFi Protected Access 2 (WPA 2), WiFi Protected Access 3 (WPA 3), or the like).

At step 404, the mobile device 125 may send an authentication request to the gateway 111. The authentication request sent by the mobile device 125 may include information identifying the mobile device 125, which may comprise, for example, an identifier such as a serial number corresponding to the mobile device 125. In some instances, the mobile device 125 may additionally input, via the dashboard 310 executing on the mobile device 125, information that may be used to verify the mobile device 125, such as a user's login information (e.g., a username and password), which may correspond to an account of the user that may be verified by a service provider associated with the gateway 111.

At step 406, the gateway 111 may validate the authentication request that was received from the mobile device 125 at step 404. For example, the gateway 111 may validate the request by verifying the serial number of the mobile device 125. In some instances, the serial number may have previously been stored at the gateway 111, and the gateway 111 may compare the serial number from the authentication request with one or more approved (e.g., whitelisted) serial numbers that are stored at the gateway 111 to find a matching serial number. Additionally or alternatively, the gateway 111 may use the input from the dashboard 310 on the mobile device 125 in validating the authentication request. Also or alternatively, the authentication server 122 may validate the authentication request using the input from the dashboard 310 and/or by matching the serial number with a corresponding approved (e.g., whitelisted) serial number stored at the authentication server 122 instead of the gateway 111. For example, the gateway 111 may forward the authentication request from the mobile device 125 to authentication server 122 so the authentication server 122 may validate the authentication request from the mobile device 125.

At step 408, the gateway 111 generate an encryption key based on validating the authentication request. For example, the gateway 111 may generate the encryption key using encryption module 330. Encryption methods may comprise Advanced Encryption Standard (AES), Rivest-Shamir-Adlemen (RSA), or the like. The encryption key may, for example, include the serial number of mobile device 125 and a medium access control (MAC) address associated with gateway 111.

At step 410, gateway 111 may send the encryption key that was generated at step 408 to mobile device 125. For example, gateway 111 may send the encryption key to mobile device 125 using communication network 101. Also or alternatively, the gateway 111 may send a credential in addition to the encryption key, in which the credential may comprise information such as a signed certificate and/or token that may subsequently be used to reauthenticate the mobile device 125, in the event the mobile device 125 disconnects and reconnects to gateway 111. Although credential is described above in that manner, credential may also refer to a username and password pair (e.g., the sensitive information) without departing from the scope of the disclosure.

At step 412, the mobile device 125 may store the encryption key. For example, mobile device 125 may store the encryption key in secure storage 320. In this manner, the mobile device 125 may use the encryption key to decrypt sensitive information (e.g., one or more encrypted username and password pairs) that may be stored at the gateway 111 and subsequently sent to the mobile device 125 (e.g., if a user associated with the mobile device 125 wishes to access an application). Also or alternatively, the gateway 111 may send encrypted sensitive information to the mobile device 125 with the encryption key. This may, for example, facilitate access to an application if a user associated with the mobile device 125 leaves the premises 102a and wishes to access an application while disconnected from the gateway 111.

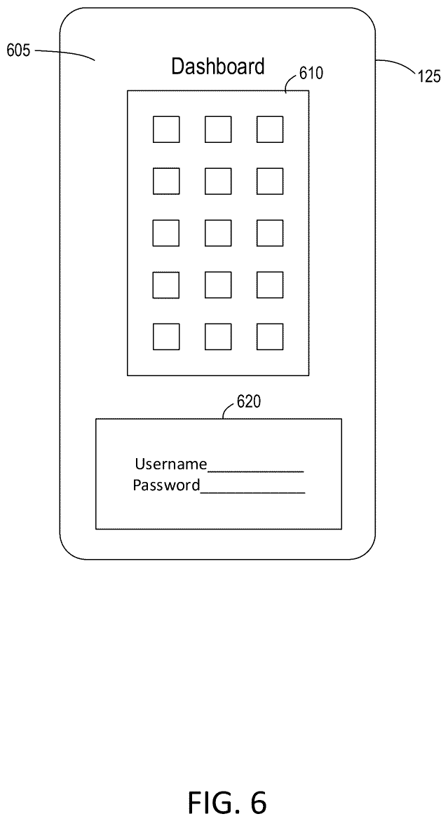

Referring to FIG. 4B, at step 414 (after step 412), the mobile device 125 may receive sensitive information. The sensitive information may be received as user input via one or more applications executing on the mobile device 125 and may comprise one or more username and password pairs associated with the one or more applications on the mobile device 125 (that enable access to external services associated with the applications, such as a streaming application, a financial application, or the like). Also or alternatively, the sensitive information may comprise information related to a digital wallet application that enables the user to access payment information, use payment information to conduct a transaction, etc., medical information, other personal information (e.g., a social security number, a driver's license number, a passport number, or the like), financial information (e.g., a bank account number and/or routing number, credit card number, or the like), and/or any other type of information that a user wishes to secure. The sensitive information may, for example, be received in step 414 as input via the dashboard 310, as discussed in more detail with respect to FIG. 6. Although some steps in the remainder of the description of FIGS. 4A-D will for convenience refer to the example of sensitive information in the form of user name and password pairs, it is understood that all steps of the method of FIGS. 4A-D (and other methods described herein) may also or alternatively be performed in connection with other types of sensitive information.

At step 416a, the mobile device 125 may encrypt the one or more username password pairs using the encryption key that was sent by the gateway 111, and received by the mobile device 125, at step 410. For example, the mobile device 125 may encrypt the one or more username and password pairs using the encryption key that was sent by the gateway 111 at step 410 and stored by the mobile device 125 at step 412.

At step 418a, the mobile device 125 may send the encrypted username password pairs to the gateway 111. As an alternative to the mobile device 125 encrypting the username and password pairs, at step 416b (alternative to step 416a), the mobile device 125 may instead send the one or more username password pairs to the gateway 111, and the gateway 111 may instead encrypt the one or more username and password pairs (step 418b).

At step 418b, the gateway 111 may encrypt the one or more username and password pairs instead of mobile device 125 encrypting the username and password pairs. For example, the gateway 111 may use the encryption key that was generated at encryption module 330 (step 408) to encrypt the one or more username and password pairs. Even so, the mobile device 125 may still use the encryption key that was sent by the gateway 111 at step 410 to subsequently decrypt one or more of the username and password pairs (step 428).

At step 420, the gateway 111 may store the encrypted username and password pairs. For example, the gateway 111 may store the encrypted username and password pairs in the secure storage 340. For example, each of the encrypted username and password pairs may be stored in the secure storage 340 with an identifier that indicates which application (and thus the external service associated with the application) the username and password pair corresponds to. As such, the gateway 111 may store sensitive information that comprises each of the encrypted username and password pairs and one or more identifiers that each indicate which applications each of the username and password pairs correspond to. Also or alternatively, if the gateway 111 is storing sensitive information such as medical information, personal information, financial information, or the like, the sensitive information may be stored with an identifier that indicates the context in which the sensitive information is associated with/used for.

After step 420, and as shown in FIG. 4C at step 422, the mobile device 125 may send a request for one or more encrypted username and password pairs in order to access a corresponding application. For example, when a user associated with the mobile device 125 would like to access an application after previously having had a username and password pair encrypted and stored at the gateway 111, the user can use the dashboard 310 to select the application that the user wishes to access, and the request can be sent to the gateway 111 accordingly. Also or alternatively, if a credential was previously sent by the gateway 111 to the mobile device 125, the mobile device 125 may send the credential as part of sending the request to gateway 111, which may be used by gateway 111 to authenticate the request (step 424).

At step 424, the gateway 111 may authenticate the request that was received at step 422. For example, the gateway 111 may authenticate the request in a similar manner to the authenticating that was initially performed at step 406, and/or by using the credential that was previously sent to the mobile device 125 by the gateway 111.

At step 426, the gateway 111 may send the requested encrypted username and password pair(s) to the mobile device 125. For example, the gateway 111 may send multiple encrypted username and password pairs to the mobile device 125, and the mobile device 125 may subsequently decrypt one or more of the multiple encrypted username and password pairs that correspond to one or more applications that a user of the mobile device 125 wishes to access. For example, the gateway 111 may send the requested username and password pair(s) to the mobile device 125 using the local network 129.

At step 428, the mobile device 125 may decrypt a desired encrypted username and password pair that corresponds to the application that the user wishes to access, using the encryption key that was used to encrypt the encrypted username and password pairs. Also or alternatively, the mobile device 125 may decrypt more than one encrypted username and password pairs without departing from the scope of the disclosure.

At step 430, the mobile device 125 may access the application that corresponds to the username and password that was decrypted at step 428. For example, the dashboard 310 may use the decrypted username and password pair to automatically login to the desired application and launch an application session by entering a website address of the application and using the decrypted username and password pair to login to the application on behalf of the user.

After step 430, and as shown in FIG. 4D as step 432, the mobile device 125 may disconnect from the gateway 111. For example, if a user associated with the mobile device 125 leaves the premises 102a, the connection (e.g., the previously established LAN connection) between the gateway 111 and the mobile device 125 that was established at step 402 may be disconnected.

At step 434, the gateway 111 may generate a new encryption key after the mobile device 125 disconnects from the gateway 111. For example, the gateway 111 may generate the new encryption similarly to the generating in step 408 and using encryption module 330. Also or alternatively, the gateway may generate a new encryption key automatically based on a period of time or a time duration associated with the storing of the encrypted username and password pairs (e.g., the storing at step 420) being exceeded (e.g., after 48 hours).

At step 436, the gateway 111 may re-encrypt the encrypted username and password pairs using the new encryption key. For example, the gateway 111 may first decrypt the encrypted username and password pairs using the original encryption key that was used to encrypt the username and password pairs before re-encrypting the username and password pairs with the new encryption key. Also or alternatively, the gateway 111 may generate a new encryption key and re-encrypt the encrypted username and password pairs based on a period of time or a time duration associated with storing the encrypted data being exceeded (e.g., after 48 hours). In this manner, the security related to the storage of the encrypted data may be increased by continuously rotating the encryption key used to encrypted the username and password pairs.

At step 438, the mobile device 125 may reconnect to and/or reauthenticate with the gateway 111. For example, step 438 may comprise performance, by the mobile device 125 and the gateway 111, of steps similar to steps 402-406. At step 440a, based on (e.g., in response to) the mobile device 125 reconnecting to and/or reauthenticating with the gateway 111, the gateway 111 may send the new encryption key to the mobile device 125. Also or alternatively to step 440a, at step 440b, the gateway 111 may send the re-encrypted username and password pairs to mobile gateway 125 in addition to the new encryption key. Also or alternatively, the gateway 111 may send a second credential in addition to the new encryption key, which may replace the original credential that was sent by gateway 111 and stored at the mobile device 125.

After steps 440a and/or 440b, steps similar to any or all of those described above may be performed (e.g., the mobile device 125 may decrypt and use the sensitive information received with the new encryption key, may use decrypted username and password pairs to access applications, may disconnect and reconnect again and receive new encryption keys and/or re-encrypted information, etc.). All or some steps (or sequences of all or some steps) may be repeated an arbitrary number of times.

Also or alternatively, although the previous steps described with reference to FIGS. 4A-4D referred to a single user and a single mobile device 125, multiple users and multiple mobile devices similar to the mobile device 125 may similarly perform the previous steps. For example, if the premises 102a is an apartment with multiple roommates, each roommate may be a user with a corresponding mobile device. The gateway 111 may separately and independently manage the sensitive information of each of the users (using, e.g., different encryption keys for each roommate). As another example, if the premises 102a is a house with a family, the parents may control the management of sensitive information of their children (by having control over the children's encryption keys).

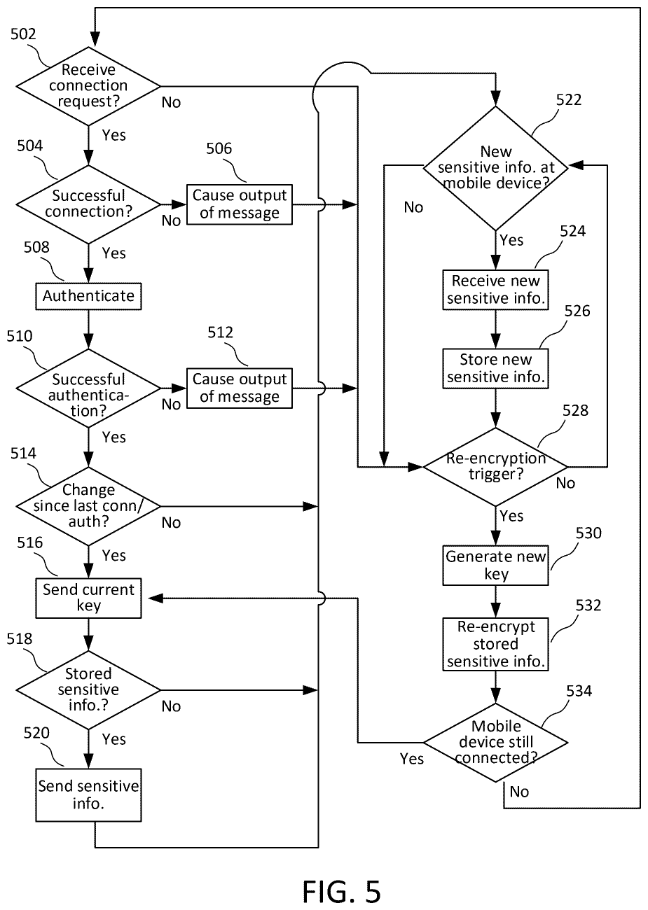

FIG. 5 is a flow chart showing an example method for using a computing device (e.g., a gateway) to securely store and manage sensitive information. One, some, or all steps of the example method of FIG. 5 may be performed by the gateway 111, and for convenience FIG. 5 will be described below in connection with the gateway 111. Also or alternatively, one, some, or all steps of the example method of FIG. 5 may be performed by one or more other computing devices. One or more steps of the example method of FIG. 5, and/or one or more communications described in connection with the method of FIG. 5, may be rearranged (e.g., performed, sent, or received in a different order), omitted, and/or otherwise modified, and/or other steps and/or communications added. A communication described in connection with the example method of FIG. 5 need not be a single message nor contained in a single packet, block, or other transmission unit. Although the method of FIG. 5 is described using the example of connection via the local network, connection via one or more networks (e.g., as described in connection with FIG. 3) may also or alternatively be used.

At step 502, the gateway 111 may receive a connection request from the mobile device 125. For example, the connection request may be received by the gateway 111 via the local network 129.

At step 504, the gateway 111 may determine if the connection was successful. If the connection was successful, the gateway may perform step 508. If the connection was not successful, the gateway may perform step 506.

At step 506, the gateway 111 may cause output of a message to the mobile device 125 that indicates the connection was not successful. In response, the mobile device 125 may subsequently attempt to successfully connect to the gateway 111. After step 506, the gateway may perform step 528 (described below).

At step 508, the gateway 111 may authenticate the mobile device 125. For example, the gateway 111 may authenticate the request by matching a serial number corresponding to the mobile device 125 to an approved (e.g., whitelisted) serial number that may be stored at the gateway 111. The authentication at step 508 may be similar to the authentication that was described with reference to FIG. 4A and step 406.

At step 510, the gateway 111 may determine if the authentication was successful. For example, the gateway 111 may determine that the authentication was successful by finding a serial number stored at the gateway 111 that matches the serial number corresponding to the mobile device 125. If the authentication was successful, the gateway may perform step 514. If the authentication was not successful, the gateway may perform step 512.

At step 512, the gateway 111 may cause output of a message to the mobile device 125 that indicates the authentication was not successful. In response, the mobile device 125 may subsequently re-attempt to be authenticated by the gateway 111. After step 512, the gateway may perform step 528 (described below).

At step 514, the gateway 111 may determine if a change has occurred since the last connection and/or authentication. For example, a change may comprise the generation of a new encryption key, decrypting and re-encrypting of stored sensitive information with a new encryption key, as described in connection with steps 530 and 532 that are further described below.

At step 516, the gateway 111 may send a current encryption key to the mobile device 125. If, for example, step 516 is being performed for an initial connection of the mobile device 125 to the gateway 111, the current encryption key may be an initial encryption key generated in an initialization procedure (e.g., as part of step 516). For example, step 516 may include a step of determining if the mobile device 125 has previously connected to the gateway 111, and if not, generating an initial encryption key. If step 516 is being performed for a connection of the mobile device 125 to the gateway 111 that is not an initial connection, the encryption key sent in step 516 may be a key generated after the initial encryption key. For example, if the mobile device 125 disconnects from the gateway (causing, e.g., a re-encryption trigger, as discussed at step 528), and the gateway 111 generates a new encryption key in response to the disconnection (as described in connection with step 530), the gateway 111 may send the encryption key generated in the most recent performance of step 530 to the mobile device 125.

At step 518, the gateway 111 may determine if the gateway 111 has stored sensitive information (e.g., one or more encrypted username and password pairs). For example, as described in connection with steps 432-436 (FIG. 4D), after the mobile device 125 disconnects from the gateway 111, the gateway 111 may generate a new encryption key and re-encrypt already-stored sensitive information using the new encryption key. If the gateway 111 has stored sensitive information associated with the mobile device 125, the gateway may perform step 520. If the gateway 111 has not stored the sensitive information, the gateway may perform step 522.

At step 520, the gateway 111 may send, to the mobile device 125, stored sensitive information associated with the mobile device 125. For example, the gateway 111 may send the sensitive information that was re-encrypted using the new encryption key that was sent to the mobile device 125 at step 516.

At step 522, the gateway 111 may determine if there is new sensitive information at the mobile device 125. This may occur if, for example, if a user of the mobile device 125 entered (e.g., after a previous disconnection from the gateway 111 and before the current connection to the gateway 11) a new username and password pair corresponding to a new application. If the gateway 111 determines that there is new sensitive information at the mobile device 125, the gateway may perform step 524. If the gateway 111 does not determine that there is new sensitive information at the mobile device 125, the gateway may perform step 528.

At step 524, the gateway 111 may receive the new sensitive information from the mobile device 125 (e.g., one or more new encrypted username and password pair(s)). For example, the sensitive information may include the one or more encrypted username and password pairs that were described with reference to FIG. 4 and steps 414-418.

At step 526, the gateway 111 may store the new sensitive information. For example, the storing may be similar to the storing that was described with reference to FIG. 4B and step 420 (e.g., storing the encrypted data in secure storage 340).

At step 528, the gateway 111 may determine if a re-encryption trigger has occurred. For example, a re-encryption trigger may comprise the mobile device 125 disconnecting from the gateway 111. As another example, a re-encryption trigger may comprise a period of time associated with the storing of the sensitive information being exceeded (e.g., 48 hours). If a re-encryption trigger has occurred, the gateway may perform step 530. If a re-encryption trigger has not occurred, the gateway may perform step 522.

At step 530, the gateway 111 may generate a new encryption key. For example, the gateway 111 may generate the new encryption key using the encryption module 330.

At step 532, the gateway 111 may re-encrypt the sensitive information stored at the gateway 111. For example, the gateway may decrypt the sensitive information using the original encryption key that was previously used to encrypt the sensitive information, and re-encrypt the sensitive information using the new encryption key generated in step 530.

At step 534, the gateway 111 may determine if the mobile device 125 is still connected to the gateway 111. If the gateway 111 determines that the mobile device 125 is still connected, the gateway may perform step 516 and the gateway 111 may send the new encryption key (generated in step 530) to the mobile device 125. If the gateway 111 determines that the mobile device 125 is not still connected to the gateway 111, the gateway may perform step 502.

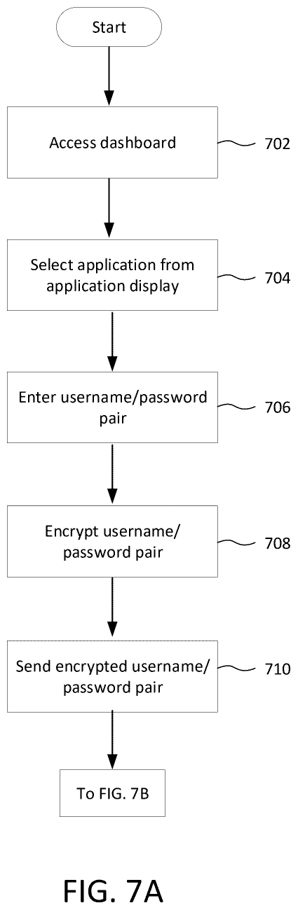

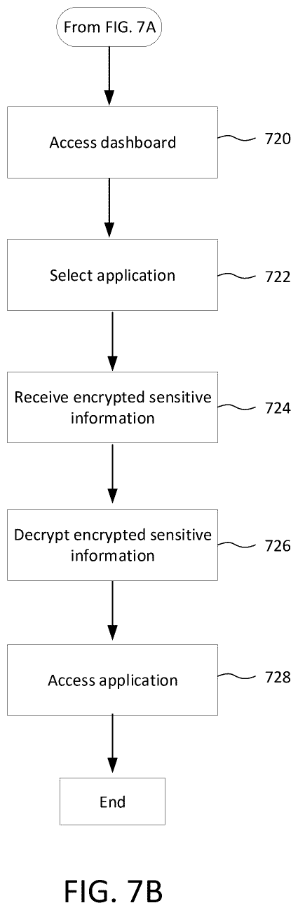

FIG. 6 shows an example of a user interface 605 that may be displayed on the mobile device 125, which may comprise an application display 610 and a username/password field 620. A user of the mobile device 125 may interact with the user interface 605 in order to perform one or more of the functions described herein (e.g., one or more of the functions described with reference to either of FIG. 3, FIGS. 4A-4D, FIG. 5, and/or FIGS. 7A-7B).

For example, upon selecting the dashboard 310 on the mobile device 125, the user interface 605 may be displayed to the user. As shown by the user interface 605, the application display 610 may comprise icons or other indicators of one or more applications installed on (or otherwise accessible via) the mobile device 125 (e.g., a streaming application, a financial application, or the like). For example, a user may select an application from the application display 610, and subsequently enter a username and password pair for that application using the username/password field 620.

Also or alternatively, if a user wishes to access an application in which the username and password pair has previously been encrypted/stored, the user may select that application from the application display 610. The dashboard 310 may retrieve and decrypt the corresponding username and password pair and automatically login to the corresponding application using the decrypted username and password pair. The application may be subsequently launched on the mobile device 125. In some instances, instead of the mobile device 125 using the dashboard 310 to launch the application, the gateway 111 may act as a proxy server and launch the application, and subsequently transfer the launched application session to the mobile device 125.

FIGS. 7A-B are a flowchart showing an example method of using a mobile device to send sensitive information to, and receive information from, a computing device (e.g., the gateway 111). Referring to FIG. 7A, at step 702, the mobile device 125 may access the dashboard 310 (using the user interface 605 that was described with reference to FIG. 6). For example, a user of the mobile device 125 may select the dashboard 310 among the applications installed on or otherwise accessible via the mobile device 125.

At step 704, the mobile device 125 may receive a selection of an application from the application display 610 shown by the user interface 605 and discussed with reference to FIG. 6. For example, a user may select a streaming application if the user wishes to access the streaming application.

At step 706, the user of the mobile device 125 may enter a username and password pair corresponding to the application that was selected from the application display 610 at step 704. For example, a user of the mobile device 125 may enter the username and password pair using the username/password field 620 (FIG. 6).

At step 708, the mobile device 125 may encrypt the username and password pair using an encryption key that was previously sent by the gateway 111.

At step 710, the mobile device 125 may send the encrypted username and password pair to the gateway 111. For example, the mobile device 125 may send the encrypted username and password pair to the gateway 111 using the local network 129. In some instances, the mobile device 125 may alternatively send the username and password pair to the gateway 111 so that the gateway 111 may instead encrypt the username and password pairs.

Referring to FIG. 7B, which may generally describe how a user associated with the mobile device 125 may retrieve and subsequently access an application, at step 720, a user of the mobile device 125 may access the dashboard 310, and subsequently, the user interface 605 may be displayed to the user.

At step 722, the user may select an application that the user wishes to access. For example, a user of the mobile device 125 may select an application from the application display 610 displayed by the user interface (FIG. 6).

At step 724, the mobile device 125 (via the dashboard 310) may retrieve the encrypted sensitive information that corresponds to the application that the user wishes to access (e.g., an encrypted username and password pair). For example, the dashboard 310 may retrieve the encrypted sensitive information from the secure storage 320.

At step 726, the mobile device 125 (via the dashboard 310) may decrypt the encrypted sensitive information that was received at step 724. For example, the dashboard 310, may retrieve the encryption key stored at the secure storage 320 and decrypt the encrypted sensitive information (e.g., the requested username and password pair).

At step 728, the mobile device 125 (via the dashboard 310) may access the application using the decrypted data (e.g., the username and password pair corresponding to the application). For example, the dashboard 310 may automatically login to the corresponding application using the decrypted username and password pair, and the application may be subsequently launched on the mobile device 125.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, from a mobile device, and a via a local wireless network associated with the computing device, sensitive information that has been encrypted using a first encryption key;
based at least on a disconnection of the mobile device from the local wireless network, re-encrypting the sensitive information using a second encryption key; and
sending, to the mobile device based on a reconnection of the mobile device to the local wireless network, the second encryption key and the sensitive information re-encrypted with the second encryption key.

2. The method of claim 1, wherein the re-encrypting the sensitive information using the second encryption key is further based a time duration, associated with the storing of the sensitive information encrypted with the first encryption key, being exceeded.

3. The method of claim 1, wherein the computing device comprises a gateway located in a premises associated with a user of the mobile device.

4. The method of claim 1, wherein the first encryption key comprises a serial number associated with the mobile device and a medium access control (MAC) address associated with the computing device.

5. The method of claim 1, wherein the sensitive information comprises:
one or more username and password pairs, wherein each of the one or more username and password pairs allows access to one or more external services; and
identifiers that indicate which of the one or more external services correspond to the one or more username and password pairs.

6. The method of claim 1, further comprising:
authenticating the mobile device, wherein the authenticating is based on:
an identifier associated with the mobile device that is stored at the computing device; and
user input, received via the mobile device, that is verified by the computing device.

7. The method of claim 6, further comprising:
sending, to the mobile device, and based on the authenticating the mobile device, a credential, and wherein the sending the second encryption key and the sensitive information re-encrypted with the second encryption key is based on receiving the credential, from the mobile device, after the reconnection.

8. The method of claim 1, wherein the sensitive information further comprises one or more of:
medical information,
personal information, or
financial information.

9. A method comprising:
receiving, by a computing device, from a mobile device, and a via a local wireless network associated with the computing device, sensitive information that has been encrypted using a first encryption key;
based at least on a time duration associated with the storing of the sensitive information being exceeded, re-encrypting the sensitive information using a second encryption key; and
sending, to the mobile device, the second encryption key and the sensitive information re-encrypted with the second encryption key.

10. The method of claim 9, wherein the computing device comprises a gateway located in a premises associated with a user of the mobile device.

11. The method of claim 9, wherein the first encryption key comprises a serial number associated with the mobile device and a medium access control (MAC) address associated with the computing device.

12. The method of claim 9, wherein the sensitive information comprises:
one or more username and password pairs, wherein each of the one or more username and password pairs allows access to one or more external services; and
identifiers that indicate which of the one or more external services correspond to the one or more username and password pairs.

13. The method of claim 9, further comprising:
authenticating the mobile device, wherein the authenticating is based on:
an identifier associated with the mobile device that is stored at the computing device; and
user input, received via the mobile device, that is verified by the computing device.

14. The method of claim 13, further comprising:
sending, to the mobile device, and based on the authenticating the mobile device, a credential, and wherein the second encryption key and the sensitive information re-encrypted with the second encryption key is based on receiving the credential, from the mobile device.

15. The method of claim 13, wherein the authenticating the mobile device is performed by an authentication server associated with the computing device.

16. The method of claim 9, wherein the sensitive information further comprises one or more of:
medical information,
personal information, or
financial information.

17. A method comprising:
receiving, by a mobile device, from a gateway, and via a local wireless network, a first encryption key;
encrypting, using the mobile device and using the first encryption key, sensitive information that comprises one or more username and password pairs;
sending, to the gateway, the sensitive information that has been encrypted with the first encryption key;
disconnecting, by the mobile device, from the local wireless network; and
receiving, by the mobile device, from the gateway, and after reconnecting to the local wireless network, a second encryption key and the sensitive information re-encrypted with the second encryption key.

18. The method of claim 17, further comprising:
decrypting, using the mobile device and the second encryption key, the sensitive information re-encrypted with the second encryption key; and
accessing, based on the decrypting, one or more applications installed on the mobile device.

19. The method of claim 17, wherein the mobile device displays a user interface that a user associated with the mobile device interacts with to enter the one or more username and pairs before the encrypting.

20. The method of claim 17, further comprising:
receiving, based on authenticating the mobile device with the gateway, a credential, wherein the mobile device uses the credential to reauthenticate with the gateway after the mobile device disconnects from the gateway and subsequently reconnects to the gateway.
